(19) United States
(12) Patent Application Publication
(10) Pub. No.: US 2007/0223408 A1
(43) Pub. Date: Sep. 27, 2007

(54) Method and Apparatus for Intelligent Seamless Network Switching

(75) Inventors: Wesley R. Thielke, Hillsborough, NJ (US); Ilmir Mousikaev, Yardley, PA (US); Peter Pomeroy, Brewster, NY (US); Hugh Sheridan, Morganville, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Broadbeam Corporation, Cranbury, NJ (US)

(21) Appl. No.: 10/595,313

(22) PCT Filed: Oct. 6, 2004
(86) PCT No.: PCT/US04/32964

§ 371 Date: Feb. 28, 2007

Related U.S. Application Data
(60) Provisional application No. 60/508,969, filed on Oct. 6, 2003.

(51) Int. Cl. H04Q 7/00; H04J 3/16

(52) U.S. Cl. 370/310; 370/353; 455/422.1; 455/445; 455/500

(57) ABSTRACT

A method and apparatus that enable a mobile electronic device to automatically and seamlessly maintain optimal network connectivity by selectively connecting to the most appropriate, currently available data or communications network. Guidelines for what constitutes optimal network connectivity are provided by pre-selected user preferences or objectives. These are combined into one or more rules that can be interpreted by a software module operating on the mobile electronics device, and used to switch between the available networks in a way that makes intelligent use of the mobile device resources, and provides seamless support for any applications running on the device while roaming through regions of changing network availability, or as the service quality of available networks varies.

### CROSS REFERENCE TO APPLICATIONS

This application is related to, and claims priority from U.S. Provisional Patent application U.S. Provisional Application 60/508,969 filed on Oct. 6, 2003 by Thielke et al. entitled “Method and apparatus for intelligent seamless network switching”, the contents of which are hereby incorporated by reference.

### TECHNICAL FIELD

The present invention relates to the field of network communication and more particularly to methods and apparatus for enabling mobile electronic devices to connect to wireless communications networks.

### BACKGROUND ART

Modern mobile electronic devices commonly have the capability to connect to more than one data or communications networks, including more than one wireless communications network. A mobile electronics device, which may be, but is not limited to a laptop computer, a cellular phone, a tablet display device or a Personal Digital Assistant (PDAs) may, for instance, access a wired or wireless Local Area Network (LANs) when the device is situated in an office or in the vicinity of a wireless “hotspot”. The same device may then switch to using a different, wide area network (WAN), such as a cellular phone wireless WAN, when not near a LAN or a hotspot.

Generally available wide area wireless protocols include, but are not limited to the General Packet Radio Service (GPRS) protocol, Global System for Mobile Communications (GSM), Radio Transmission Technology protocol (1xRTT), the Enhanced Data GSM Environment (EDGE) protocol, Universal Mobile Telecommunications System (UMTS) protocol and the Mobile Text Transfer System (Mobitex) protocol.

In addition, it is becoming increasingly common for mobile electronic devices to be capable of using more than one of these wide-area network protocols. Details of mobile electronics devices configured in such a manner may be found in, for instance, U.S. Pat. No. 6,608,832 issued to Forslow on Aug. 19, 2003, entitled “Common access between a mobile communications network and an external network with selectable packet-switched and circuit-switched and circuit-switched services”, the contents of which are hereby incorporated by reference.

When a mobile electronic device is capable of operating on more than one protocol and more than one LAN or WAN is available, the device user is faced with the decision of selecting between the different services. Which network to choose at any given time may be a complex choice as it depends partly on what networks are available, partly on what applications the communications device is being used for, and partly on the objectives of the user, such as whether they want to maximize bandwidth, minimize cost or maximize device battery time.

There are also dangers to switching between networks. For instance, applications running on mobile or nomadic systems face the problem that a mobile client, as it roams from one network to another, may be mistaken by a server on that network for a second client rather than being recognized as the original client. This can cause problems in an application requiring continuity of state.

Detecting which networks are available, determining their currently quality of service and then selecting which one will provide the service that best matches the applications being run and the users objectives, can be a tedious task if done manually. What is required is an automated system and method for making such decisions.

### DISCLOSURE OF INVENTION

The present invention relates to methods and apparatus that enable mobile electronic devices to automatically and seamlessly maintain optimal network connectivity by selectively connecting to the most appropriate, currently available data or communications network.

In a preferred embodiment of the invention, guidelines for what constitutes optimal network connectivity may be provided by pre-selected user preferences or objectives, and quality of connection parameters for the networks. These user preferences and quality of connection parameters may be combined into one or more rules. A software module operating on the mobile electronics device may parse these rules into instructions that enable switching between the available networks in a way that makes intelligent use of the mobile device resources and provides seamless support for any applications running on the device while roaming through regions of changing network availability, or as the service quality of available networks varies.

In a preferred embodiment, the invention includes one or more network detectors, one or more network controllers, a switching rules engine and a data traffic detector. The network detector may make use of existing system applications to detect connections to networks. For instance the network detector may infer the availability of a network by detecting the activation or deactivation of Network Driver Interface Specification (NDIS) drivers, such as those found on Windows and Window CE devices. These drivers may, for instance, appear and disappear as LAN modems acquire or lose connection to an access point. The network detector or controller may further utilize the mobile electronic device's operating system utilities, such as the well known Packet Inter-Network Groper (PING) protocol that is implemented on most operating systems as a utility, to ensure that the network located contains Internet protocol addresses within a pre-authorized range, to periodically check the status or condition of the connection or to ensure that a particular network server is reachable via a connection. The network controller ensures that routing tables are appropriately managed by for instance, but not limited to, correctly managing Dynamic Host Configuration Protocol (DHCP) functions such as “Release” and “Renew”. The purpose of the data traffic detector includes indicating that an application requires a network connection and indicating network activity related to an application. The data traffic detector may for instance utilize, but is not limited to, the Winsock Layered Service Provider (LSP) interface or the Transport Driver Interface (TDI) on Microsoft platforms. The data traffic detector may be configured to react differently depending on the application that is generating the traffic. For example, traffic from an Automatic Vehicle Location (AVL) application that periodically sends GPS location updates to a server might be considered unsuitable for the purpose of initiating a network connection or for indicating application activity. The indication of application activity may be used to keep connections alive, or, lacking activity, to terminate them.

The switching rules engine may be preloaded with rules that incorporate pre-selected client preferences or objectives, including items such as but not limited to, authorized network names, detection modes, access parameters, phonebook entries, user-assigned network priorities and preferred modes of operation. Preferred modes of operation include, but are not limited to, “always on”, in which the rules engine will attempt to always maintain a connection, to “connect on demand” in which the engine will only establish connections when an application has data to send, and a manual mode, in which the preferred decision is displayed to the user but any necessary action is left to the user to perform.

Using the preloaded rules, data from the network detectors and the data traffic detector, the switching rules engine may make and implement decisions regarding which network to connect to via the network controller, and so provide intelligent, seamless network switching. These and other aspects of the invention will be described in greater detail by reference to the attached drawings.

### BRIEF DESCRIPTION OF DRAWINGS

FIG. 1 is a schematic representation of an exemplary embodiment of an intelligent Seamless Network Switching (SNS) engine of this invention.

FIG. 2 is a schematic representation showing a stand-alone implementation of an SNS engine in relation to exemplary device-resident software modules.

FIG. 3 is a schematic representation showing a further implementation of an SNS engine in relation to exemplary device-resident software modules.

FIG. 4 is a flow diagram showing the functioning of an exemplary embodiment of an intelligent Seamless Network Switching (SNS) engine of this invention.

### BEST MODE FOR CARRYING OUT THE INVENTION

The present invention relates to methods and apparatus that enable mobile electronic devices to automatically and seamlessly maintain optimal network connectivity by selectively connecting to the most appropriate, currently available communications network, and in particular to an intelligent Seamless Network Switching (SNS) engine that may be integrated in with applications and operating system components resident on the mobile electronic device.

In a situation where a mobile electronics device requires network access and has the capability to connect to more than one available network, a decision has to be made on which network to connect. A number of factors influence this choice including, but not limited to, the quality of service currently available on the networks, the state and connectivity requirements of applications currently running on the mobile device, the mobile device resources, including battery state, and user objectives such as, but not limited to, minimizing cost, minimizing data transmission costs or maximizing data integrity. Many of these factors can vary with time or as the mobile device roams from point to point. Switching between available networks as availability and service change can present a complex problem.

Prior approaches to this problem of how to run applications on clients that have intermittent connection to a server that requires their state to be maintained, have included providing a virtual client service to maintain that state during client unavailability as described in for instance, U.S. Pat. No. 6,546,425 entitled “Method and Apparatus for Providing Mobile and Other Intermittent Connectivity in a Computing Environment”, issued to Hanson et al. on Apr. 8, 2003, the contents of which are hereby incorporated by reference. However, such an approach requires the extra expense of a virtual client service.

The present invention is a more cost effective solution to the problem, comprising a middleware software application running on the client that intelligently and seamlessly manages network connections, including switching in response to client requirements such as application traffic. In a preferred embodiment, a software module incorporating the inventive concepts of the present invention also informs the server of any connection changes, and/or mimics the original connection parameters, so that the server does not confuse client identity, and applications can maintain session persistence as the device roams between different network connections. The software is also capable of following rules based on pre-selected user preferences to make decisions such as whether connections to particular networks should be limited in order to conserve battery life, or to reduce the cost of maintaining a circuit-switched connection. In addition, the software is capable of detecting applications that have special needs such as, but not limited to, requiring best efforts to maintain a constant connection to a network, even in the face of network coverage losses and roaming between different networks, and act appropriately to meet those needs. Software modules incorporating the methods of the present invention also allow data to be sent as quickly as possible from the mobile electronic device or, conversely, for data to be pushed to the mobile electronic device from some server application. Automation of this type of “always on” mode is also supported by this invention.

To understand the inventive concepts of the present invention it is useful to consider the accompanying drawings in which, as far as possible, like numbers represent like elements.

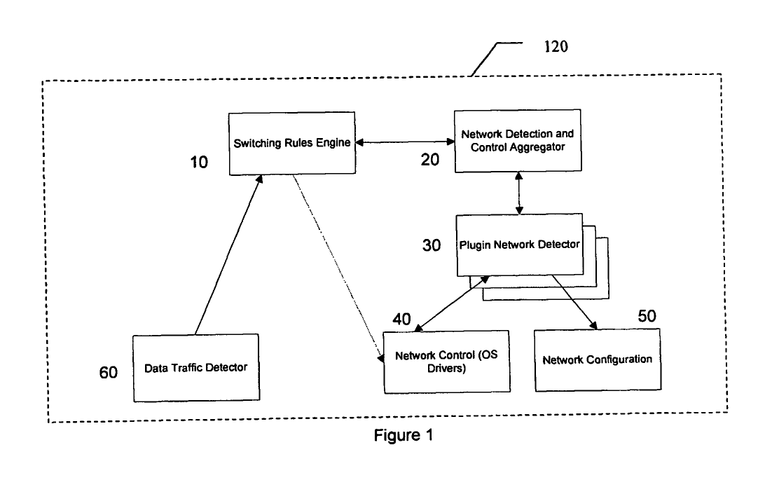

FIG. 1 shows a schematic view of a basic version of the invention. In a preferred embodiment, the intelligent Seamless Network Switching (SNS) engine 120 consists of a rules-based switching engine 10, aided by network detection-and-control modules 20 and a data traffic detector 60. The network detection-and-control module 20 is designed to accommodate network or manufacturer-specific plug-in modules 30. These plug-in network detector modules 30 interface with the mobile electronic device's operating system's network control drivers 40 or with the mobile electronic device's network configuration driver 50. In this way, the rules-based switching engine 120 is able to perform functions such as, but not limited to, detecting changes in the availability of a network, initiate and terminate connections to a network or network device, provide connectivity and signal-strength feedback to the user or applications running on the mobile electronic device, and make changes in network configuration, such as internal routing tables, to achieve proper utilization.

The data traffic detector 60 may, for instance, be a software module which can be configured in a per-application mode. In this per-application mode, the traffic detector is provided with pre-selected user preferences identifying the applications on the mobile electronics device that may drive connections. An application that drives a connection is an application that has the capability of notifying an SNS engine 120 that a connection is either needed or no longer needed, and of indicating application activity to the SNS engine 120 so that network inactivity rules for dropping connections can be activated. An application's ability to drive connections may be further configured to apply only to specific networks or network types. Applications may be assigned connection-driving parameters that indicate which, if any, networks they may drive connections on.

Network detection may be performed by a number of methods. In a preferred embodiment of the invention, network detection capability is provided to the switching rules engine 10 through one or more network plugins and is implemented to be as generic as possible. The actual modules and methods used for detecting networks in any specific implementation may take different forms, depending on the types of network being detected, as described below.

Lan detection. If the mobile electronic device is operating using a Window™ or Windows CE™ operating system supplied by the Microsoft Corporation of Seattle, Wash., wired connections, such as but not limited to an Ethernet connection, and wireless LAN connections may be detected by watching for the appearance and disappearance of network interfaces through the use of those operating systems' Network Driver Interface Specification (NDIS) Application Program Interface (API). It is also possible for modem-type connections to be implemented with such an interface. Typically, these interfaces will appear and disappear dynamically as cables are plugged in or removed, Peripheral Component Microchannel Interconnect Architecture (PCMCIA) cards are inserted or removed or wireless LAN modems acquire or lose a connection to an access point.

Once the connection has been detected by the switching rules engine 10, the usability of the connection can further be tested to ascertain whether the interface address belongs to a configured sub-network. For example, if a company's wireless LAN has a sub-network that has addresses in the range 10.1.x.x, then this sub-network can be defined to the switching rules engine 10 as being a valid address. The network will be used only if the address falls in the right range. How this network detection is accomplished can differ from one operating system to another. For example, it can be different between standard Windows™ 32 operating systems and Windows™ CE.

In addition, a Packet Internet Groper (Ping), a standard protocol which is implemented as a utility on most operation systems, can be used to confirm the usability of the network. Ping is a standard way of determining whether a particular computer is currently connected to the Internet. It consists of an Internet Control Message Protocol (ICMP) echo-request and echo-response. In practice Ping comprises sending a packet to the specified Internet Protocol (IP) address and waiting for a reply. The use of the Ping protocol is further described below.

If a detected network connection appears to have lost usability, the Dynamic Host Configuration Protocol (DHCP) has commands, such as the “Release” and “Renew and Release” that may be used to ensure that the device is properly activated and that routing tables in the IP stack are properly set when a network change occurs. DHCP is a standard protocol for automating the configuration of computers that use Transmission Control Protocol with Internet Protocol (TCP/IP).

The generic implementation of SNS includes a standard plugin implementation for LAN-type networks.

Wide-Area Networks. Modem manufacturers typically provide special drivers that allow both data and command connections to be made to the modem at the same time. Some manufacturers of General Packet Radio Service (GPRS) protocol modems, for example, provide drivers which take advantage of the Global System for Mobile Communications' GSM 07.10 multiplexing protocol, implemented by providing multiple virtual COM ports on a PC. One of these virtual ports can be used by an SNS plugin to detect the availability of a GPRS network, independent of any data connections that may be active.

Other modem manufacturers, for example, Sierra Wireless of Richmond, British Columbia, Canada, offer proprietary APIs for communicating with a modem independent of data connections. These APIs can also be used by an SNS plugin to perform network detection as well as radio-awareness feedback such as, but not limited to, providing signal strength and battery level.

Ping. Pings can be used periodically by a network plugin component to both detect the availability of a network and to detect when a network connection fails. This is often better than relying on the network interface or information from the modem itself, because it can help determine the quality of a connection. The SNS interface allows defining a pingable address that is relative to the base sub-network address of the connection made. For example, in a GPRS network, the actual address range assigned at any time may depend on the network switch selected during the roaming process. However, there is usually a pingable network gateway within the GPRS network, whose address can be determined relative to the sub-area's sub-network. The use of Ping is configurable. It is not always desirable to use Ping, because of network costs that may be incurred through its use.

Ping is used intelligently, in order to minimize the cost on some networks. If application data traffic is sensed, or if an application indicates that Ping should be suspended, Ping operation can be temporarily suspended.

Ping can also be used as a means to keep a connection alive to prevent the network from prematurely timing out on a connection. For example, in GPRS networks, it is common for the carrier to deactivate a connection after 5 minutes of inactivity. The Ping interval could be used to ensure that the device stays active.

It is important that Ping not be executed too frequently once the network has been detected, in order to minimize costs in terms of network fees as well as battery life.

In addition, there are certain types of networks for which detectors are not possible such as, but not limited to, connections made via Dial-Up Networking (DUN) phonebook name. In these situations, a simple trial and error approach to network detection is used, i.e. attempts are make to connect to listed network addresses in order of priority until connections are established.

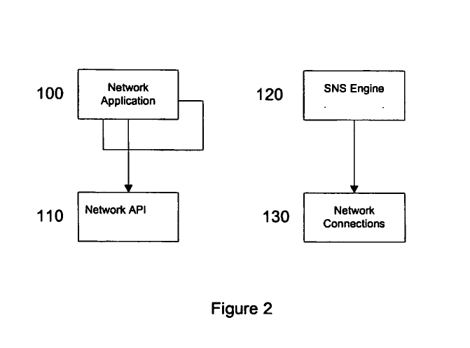

FIG. 2 is a schematic representation showing a stand-alone implementation of an SNS engine in relation to exemplary device-resident software modules. In this embodiment, the SNS Engine 120 runs as a stand-alone process. The SNS Engine 120 detects and controls one or more network connection modules 130, as previously described. However, in this embodiment, one or more Networking applications 100 use networking APIs 110, such as Winsock, a standard application that allows Windows programs to communicate with other machines using the TCP/IP protocol, to communicate, but do not directly control connections with any networks or network devices. This embodiment of the invention may include utilizing the traffic detectors that are imbedded in the network stack of the operating system such as, but not limited to, the Winsock 2 Layered Service Provider (LSP) interface and/or the Transport Driver Interface (TDI), which aid the SNS Engine in determining when to connect and disconnect from available networks. In particular, the LSP is one way in which the SNS engine 120 operating in a connect-on-demand mode, can ascertain a need for a connection by an application.

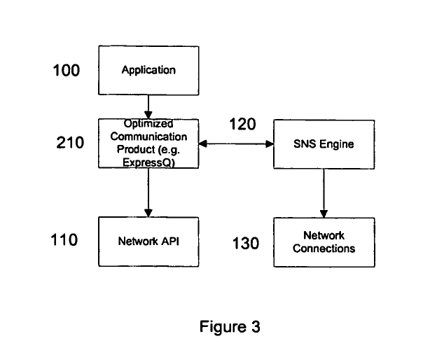

FIG. 3 is a schematic representation showing a further, network-aware implementation of an SNS engine in relation to exemplary device-resident software modules. In this embodiment, a network-aware communications program, such as the ExpressQ™ client (210) supplied by the Broadbeam Corporation of Cranbury, N.J., is used to invoke the services of the SNS Engine 120. Aided by input from such a program, the SNS Engine 120 is capable of making better decisions as to when to connect and disconnect. In addition, the SNS Engine 120 can provide network feedback to the application, which can, in turn, be used to make communications decisions in the application or to display network availability information to the user. For instance, the network feedback may be provided to the application via an applications communications API that applications use to communicate with the SNS Engine 120. The application may make use of the network feedback to provide more intelligent or efficient use of the network connections and aid them in implementing session persistence across changing network conditions.

The SNS Engine 120 applications communications API allows other applications to interact with it. The applications communications API has two main purposes: (1) Allowing applications to actively indicate connection needs and application activity and (2) allowing applications to receive event notifications regarding SNS Events and information. SNS events include, but are not limited to, the coming and going of network connections and the types of connections made. SNS information includes, but is not limited to, network-related information like signal strength and battery level. The applications communications API also has a provision whereby the SNS engine 120 can request permission to perform a network switch. For example, if a higher priority network becomes available, the SNS engine 120 may ask the API clients whether a switch is permissible. In some cases, an application may prefer to finish what it is doing on the current network before allowing a switch to occur.

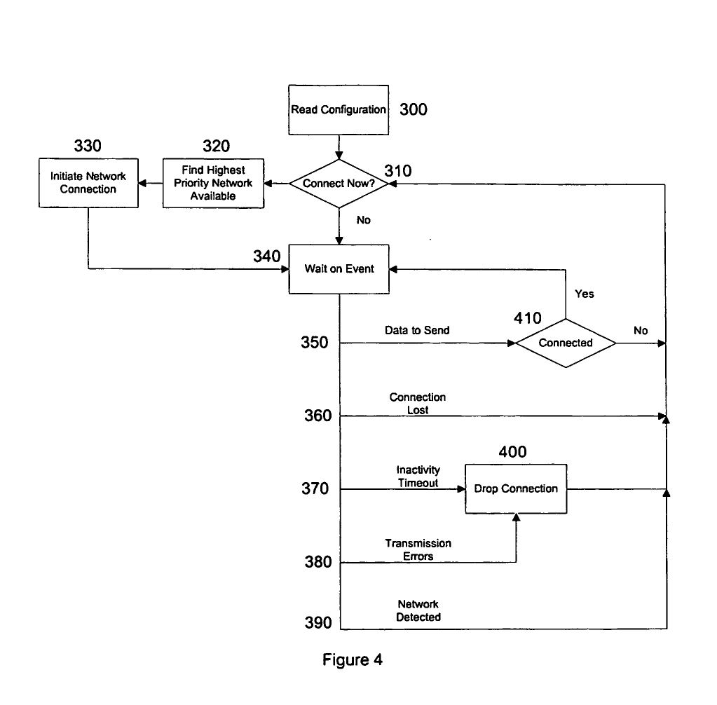

FIG. 4 is a flow diagram showing the basic workings of an intelligent Seamless Network Switching (SNS) engine 120 incorporating a Switching Rules engine 10. The installation of the Switching Rules engine 10 requires at least the following information:
a. The identification of the networks to control, either by network interface name or Dial-Up Networking (DUN) phonebook name. The installer can automatically browse for and suggest networks that could be used.
b. The priority of each network relative to the others.
c. The operation mode: “Always On” or “Connect on Demand”
d. Details for specific configuration items such as the Ping offset or valid network addresses.

These and other relevant information are first read in by the engine in step 300 as configuration information. This configuration information defines the priority and other characteristics of the networks to be used. This information is typically preloaded and may also be user edited. The following is a typical example of configuration information, in which the SNS component is configured through an initialization (INI) file, with the following sections and keywords:

[SWITCHING]

CHANNELS=WLAN GPRS GSM

The CHANNELS keyword lists the names of the section names pertaining to the networks to be controlled.

[LAN] (The name of the network-specific section)
;PRIORITY controls the priority relative to the other networks and the inherent switching order
PRIORITY=n
;PLUGIN_DLL names the plugin component (a DLL) for this network DETECTION_PLUGIN=BBNDLAN.DLL
;DETECTOR_NAME names the specific detector from the detector DLL
DETECTOR_NAME=LANINTF
;DUN_SUPPORT indicates whether the network is controlled through Dial-Up Networking
DUN_SUPPORT=NO
;DUN_PHONEBOOK_ENTRY specifies the name of the DUN phonebook entry used to control this network
;DUN_PHONEBOOK_ENTRY=gprs
;CLEAR_AFTER governs an inactivity timeout for a DUN connection for this network, specified in seconds
CLEAR_AFTER=30
;INACTIVITY_INTERVAL specifies an inactivity interval for the network as a whole. When this interval expires, then a new network is sought out
;RETURN_CHANNEL specifies the name of the next network to try if this network fails. For example, if there are two modems, each supporting GPRS and GSM (GPRS1, GSM1, GPRS2, GSM2), specified in the order (GPRS1, GPRS2, GSM1, GSM2), then the RETURN_CHANNEL for GSM1 might be GPRS2, because a failure on GSM1 might indicate that the network for GPRS1 is not available.
RETURN_CHANNEL=GPRS1
;VALID_NETWORK_ADDRESS is used to indicate how a valid network address for this network is formed in order to recognize it. The form is IP_ADDRESS/N, where IP_ADDRESS represents the high-order bits in the address and N indicates how many bits are significant. For example, 10.1.0.0/16 indicates that the first 16 bits of the network address must match 10.1 in order to be recognized as belonging to this network.
;PING_INTERVAL indicates the interval, in seconds, between pings to determine the continuity of network availability
PING_INTERVAL=120
;PING_OFFSET is used to indicate an offset in the current sub-network range to be used as the destination address for pings. The address is formed as IP_ADDRESS/N, where N indicates the number of bits to use. For example, 0.0.1.1/16 indicates that the rightmost 16 bits make up the offset and should be added to the network prefix (the remaining leftmost bits). The default offset is 32, indicating an absolute address.
;PING_OFFSET=0.0.1.1/16
;PING_TIMEOUT is the interval, in milliseconds, after which a Ping request is considered to have failed, having received no response
PING_TIMEOUT=1000
;PING_RETRY_NUMBER indicates the number of failed consecutive ping attempts that will cause a ping failure to be signaled
PING_RETRY_NUMBER=3

Having read the configuration information in step 300, the SNS engine 120 moves to step 310, in which, if there is not currently a live network connection, the engine must determine whether to activate a connection. The decision of whether to make or maintain a connection is governed by factors such as, but not limited to:
1. Whether an application is currently trying to send data.
2. The mode of operation, which may include “always on” mode or “connect on demand” mode or a “manual mode” in which a decision on optimal connectivity is reached and displayed or otherwise conveyed to the user, but no switching occurs. This mode allows the user to implement the decision or not.

When the decision has been made to attempt a connection, the system moves to step 320 and seeks out a suitable network. Networks are defined by priority as part of the configuration file. The SNS engine builds a sequential list of usable networks, giving each a priority. Lacking any other criteria, networks are searched in priority order for availability.

Plugin detectors can provide availability information. One of the purposes of the network plugin modules is to perform network detection. If a network has a detector and the detector indicates the network is available, this network will be selected, if it is the highest priority of such available networks. Conversely, if a network has a detector and the detector indicates that the network is not available, no attempt will be made to connect to that network. Likewise, when a detector indicates the loss of a network's availability, a switching process will be initiated away from that network.

When there is no detector for a network, a connection to that network will simply be detected, for example by attempting to establish a Dial-Up Networking connection to the modem. If the connection attempt fails a configurable number of times, the selection process continues with another network.

Step 320 of finding the highest priority network is aided by the use of network detectors. For example, if a high-speed LAN or wireless LAN connection is available, it may be desirable to connect to that network immediately to achieve the fastest communications, or it may not be desirable to do this unless the application actually has data to send.

Once a potential target network has been found, a connection will be attempted in step 330. If the connection attempt fails for any reason, the next lower priority network will usually be attempted.

Most of the time in the engine is spent waiting on events 340. These events can include the following:

a. Data to Send, step 350. If an application has data to send, as indicated by a traffic-detector or by an explicit notification from an integrated application, and there is not currently any network connection, then the network selection process is activated.

b. Connection Lost, step 360. If a network connection is lost, then the network selection process is activated.

c. Inactivity Timeout, step 370. If a network connection is active, but there has been no activity for a pre-configured amount of time, then the connection will be dropped, after which the decision when next to connect is revisited.

d. Transmission Errors, step 380. If one or more transmission errors occur, indicating a troublesome network connection, the current connection can be dropped, followed by the network selection process.

e. Network Detected, step 390. If the availability of a network is detected, the situation will be evaluated. It is possible that the current network connection will be dropped in favor of connecting to a higher speed connection that has become available.

The Transmission Errors of step 380 can be detected in at least two different ways, such as an application can signal a transmission error by calling the SNS application interface or a transmission or connection error can be detected by the Data Traffic Detector imbedded in the Winsock stack.

In either case, transmission errors can be configured with retry parameters to control how many errors must occur before a switch is actually attempted. This is done in order to prevent transient errors from causing too frequent network switching.

The various embodiments of the invention may be appreciated further by considering the following specific user cases, which also more clearly demonstrate the usefulness of this invention. The case studies highlight ability of the invention to proactively activate and deactivate network connections, so that the user does not have to do this manually and the ability of the invention to use its knowledge of application activity to establish connections when there is something to send and disconnect when applications have finished sending.

Case 1: Ambulance Service

In this example of use of the invention, an ambulance service employs laptop computers in ambulances. Each laptop is equipped with an 802.11b (wireless LAN) modem, a combination GPRS and GSM modem and the intelligent SNS engine of this invention. The objective is to remain connected to at least one network at all times, if possible. This is required in order to enable a central operator/dispatcher function to assign emergencies to the ambulance closest to the emergency. Central needs to be able to initiate and exchange of information with the ambulance, which can only be done when the ambulance is connected to a network. This is the SNS “always on” mode. If a wireless LAN is in range and useable, then any existing wide-area connections are to be dropped in favor of the higher-speed wireless LAN network. The second priority network is the GPRS packet radio network. As a last resort, a circuit-switched GSM connection is to be established. In addition to doing the network detection and switching, the seamless network switching component provides feedback to an application regarding the current connectivity, so that the application can notify its server about new connection addresses, in case the server application needs to push data to the mobile client.

An important role played by the SNS engine 120 in this case example is the ability to proactively seek out the best connection possible without human intervention. This is done through the SNS 120 detecting network availability as well as monitoring application activity. The result is higher user productivity and a better user experience.

Case 2: Browser

In this case example, the application is an Internet browser, such as the Microsoft Internet Explorer. The PC device being used has two wireless modems: an 802.11 modem and a GPRS modem and is also loaded with a version of the intelligent SNS engine. The SNS engine in this example is pre-configured so that whenever a useable 802.11 network is detected, an immediate switch to use it is desired. When not in wireless LAN coverage, GPRS connectivity is attempted. The GPRS connectivity is maintained until wireless LAN coverage is available again. Switching between networks is not usually a problem, because the HTTP requests and responses used by the browser are short and session less. Push is not required.

The intelligent SNS engine is useful in this application because it reduces the time the end user has to spend managing the connections and switching back and forth between them, and the SNS engine makes the ‘multi-network’ capable device easier to use. For enterprises, this makes users more productive and requires less training. For consumer users, having the intelligent SNS engine of this invention provides a better user experience and allows service providers and ISVs to differentiate their offering based on ease of use.

Case 3: Browser with GPRS/GSM

This case example is similar to the previous case which the application is a browser, except that GSM is also a possibility. In this case, the intelligent SNS engine is configured so that a connection to the GSM network will be attempted whenever wireless LAN and GPRS are not available, but only when the application actually is trying to do something. This state may be detected by, for instance, the application traffic detector imbedded in the Winsock 2 stack on the PC and relayed to the SNS engine 120. In addition the SNS engine may also be configured so that the GSM connection may be automatically disconnected after a period of inactivity, in order to minimize connection costs.

In addition to the value illustrated by the previous browser example, this case highlights the ability of the invention to control the costs of connecting to a circuit-switched network by connecting only when there is something to do and disconnecting as soon as possible.

Case 4: Field Service Using 802.11 Hotspots

In this case, a field service technician uses a laptop configured with 802.11 and GPRS modems and the ISNS system. Like the previous examples, the intelligent SNS engine is configured so that a GPRS connection is attempted when a wireless LAN is not available. However, in this case example, because the wireless LAN traffic is billable based on connection time, connection time has been selected as a parameter that needs to be minimized. The Switching Rules Engine 10 therefore automatically ensures that a connection is only made when an application actually has something to do. This is, again, detected by the application traffic detector and relayed to the SNS engine 120.

This case again illustrates the value of the invention in eliminating manual intervention creating connections, thereby improving productivity and user experience, as well as the ability to control costs.

Case 5: Application with Location Updates

In this case, a PC device having the ISNS system also has both GPRS and GSM capability. In addition to business data, the application also sends regular GPS updates to a backend server, which uses this information to track the user's location. However, these GPS messages should only be sent when there is actually a network connection available. They should not be sent when no connection is available, because an attempt to send them might trigger a GSM connection that would be costly. Therefore, the application uses feedback from the SNS component to know when and what type of connections are currently available so that this logic or requirement that has been entered in the configuration file can be implemented by the Switching Rules Engine.

This case example illustrates the ability of applications to work effectively in conjunction with the SNS engine 120 of this invention by using feedback provided by the invention.

A further reason for using the SNS engine 120 of the present invention is to provide a mobile device with operating system, network, manufacturer or modem-specific code to access a network. Manufacturer-specific implementations are often quirky, in spite of standards. The SNS engine 120 of the present invention may also provide the mobile device with network detection capability, the ability to initialize and terminate network connections, radio-awareness feedback, such as signal strength, modem battery level, network availability, to the SNS engine 120 and applications, and device-specific methods of keeping connections alive or disconnecting for inactivity.

The above-described steps can be implemented using standard well-known programming techniques. The novelty of the above-described embodiment primarily lies not in the specific programming techniques but in the use of the steps described to achieve the described results. Software programming code which embodies the present invention is typically stored in permanent memory of some type, such as permanent storage of a workstation located at Broadbeam Corporation's headquarters in Cranbury, N.J. In a client/server environment, such software programming code may be stored in memory associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention

While this invention has been described with reference to the preferred embodiment thereof, it will be appreciated by those of ordinary skill in the art that modifications can be made to the structure and elements of the invention without departing from the spirit and scope of the invention as a whole.

### INDUSTRIAL APPLICABILITY

In the field of telecommunication there is significant interest in having mobile devices automatically and seamlessly maintain optimal network connectivity by selectively connecting to the most appropriate, currently available data or communications network.

1. An apparatus for intelligent, seamless switching between a plurality of data or communications networks, comprising:
a mobile electronics device;
a network connection means, operable on said mobile electronics device, for connecting said mobile electronics device to said plurality of networks;
a network monitoring means capable of measuring at least one quality of connection parameter for said plurality of networks; and
a selection means, responsive to at least one pre-selected user preference and responsive to said at least one quality of connection parameter, for selectively connecting said mobile electronics device to one of said networks.

2. The apparatus of claim 1 where said network connection means is capable of establishing a wireless connection to at least one of said plurality of networks.

3. The apparatus of claim 2 wherein said selection means further comprises: means for detecting a network; means for processing said client preferences; and means for detecting data traffic.

4. The apparatus of claim 3, wherein said pre-selected user preference is one or more of a network identifier, an application's connection-driving parameter, a network detection mode, a mode of operation and a pre-assigned network priority.

5. The apparatus of claim 4, wherein said mode of operation is selected from an always-on mode and a connect-on-demand mode.

6. The apparatus of claim 5, wherein said connect-on-demand mode comprises only connecting to one of said networks when said means for detecting data traffic indicates an application requiring network access.

7. The apparatus of claim 1, wherein said quality of connection parameter is one or more of a ping interval, a ping-offset, and a ping timeout.

8. The apparatus of claim 1 further comprising means for providing said quality of connection parameter to an application running on said mobile electronic device.

9. A method of intelligent, seamless switching between networks, said method comprising the steps of:
providing a mobile electronic device;
providing a first and a second network connection capability operational on said mobile electronic device;
providing a rule comprising at least one pre-selected user preference and at least one quality of connection parameter; and
selecting one of said first and second network connection capabilities responsive to said rule.

10. The method of claim 9 wherein said first and second network connection capability comprise a wireless communications link.

11. The method of claim 10, wherein said pre-selected user preference is one or more of a network identifier, an application's connection-driving parameter, a detection mode, an accesses mode, a network priority, and a mode of operation.

12. The method of claim 11, wherein said mode of operation is selected from an always-on mode and a connect-on-demand mode.

13. The method of claim 12, wherein said connect-on-demand mode comprises only connecting to one of said networks when an application requiring network access is detected.

14. The method of claim 9, wherein said quality of connection parameter is one or more of a ping off-set, a ping interval and a ping timeout.

15. The method of claim 1 further comprising the step of providing said quality of connection parameter to an application running on said mobile electronic device.

16. A computer-readable medium, operable in conjunction with a mobile electronic device having a first and a second network connection capability, said computer-readable medium comprising instructions for:
parsing a rule comprising at least one pre-selected user preference and at least one quality of connection parameter for said networks; and
selecting one of said first and second network connection capabilities responsive to said rule.

17. A computing device comprising: a computer-readable medium operable in conjunction with a mobile electronic device having a first and a second network connection capability, said computer-readable medium comprising instructions for:
parsing a rule comprising at least one pre-selected user preference and at least one quality of connection parameter for said networks; and
selecting one of said first and second network connection capabilities responsive to said rule.

18. A method of maintaining an optimal network connection, comprising the steps of;
providing a mobile electronics device;
running one or more applications on said mobile electronics device, said applications requiring data to be sent to a remote server;
automatically detecting, by a network switching software module running on said mobile electronics device, two or more available wireless communications networks suitable for sending said data to said remote server;
automatically selecting one of said two or more available wireless communications networks by said network switching software module running on said mobile electronics device, responsive to at least one pre-loaded rule comprising a connection cost factor;
automatically establishing a communications connection, by said network switching software module running on said mobile electronics device, using said selected wireless communications network; and
sending said data from said application to said remote server.

19. The method of claim 18 wherein said step of automatically selecting is further responsive to at least one pre-loaded rule comprising a factor for minimizing a data transmission cost.

20. The method of claim 18 wherein said step of automatically selecting is further responsive to at least one pre-loaded rule comprising a factor for maximizing data transmission integrity.

21. The method of claim 18 further comprising detecting, by said network switching software module running on said mobile electronics device, said data required to be sent by said one or more applications and, when no data is required to be sent, disconnecting said communications connection.

22. An apparatus for maintaining an optimal network connection, comprising;
a mobile electronics device;
one or more software applications operable in conjunction with said mobile electronics device, said applications requiring data to be sent to a remote server; and
a network switching software module, operable in conjunction with said mobile electronics device, said network switching software module comprising instructions for:
automatically detecting two or more available wireless communications networks suitable for sending said data to said remote server;
automatically selecting one of said two or more available wireless communications networks responsive to at least one pre-loaded rule comprising a connection cost factor;
automatically establishing a communications connection using said selected wireless communications network; and
sending said data from said application to said remote server.

23. The apparatus of claim 22 wherein said network switching software module further comprises instructions for selecting one of said two or more available wireless communications networks responsive to at least one pre-loaded rule comprising a factor for minimizing a data transmission cost.

24. The apparatus of claim 22 wherein said network switching software module further comprises instructions for selecting one of said two or more available wireless communications networks responsive to at least one pre-loaded rule comprising a factor for maximizing data transmission integrity.

25. The apparatus of claim 22 wherein said network switching software module further comprises instructions for detecting said data required to be sent by said one or more applications and, when no data is required to be sent, disconnecting said communications connection.

26. The method of claim 18 wherein said step of sending data further comprises selectively sending said data from said application dependent on said network selected.

27. The method of claim 18 further comprising the steps of switching said communications connection from a first selected network to a second selected network; and informing said remote server of said switching.

28. The method of claim 27 further comprising the step of conserving battery life.

29. The method of claim 28 wherein said step of conserving battery life comprises said mobile electronics device operating to reduce data traffic, to optimize a transport protocol, to optimize an application protocol or to reduce duplication of work by a user through connection persistence or a combination thereof.

30. The method of claim 27 further comprising the steps of maintaining session persistence by said remote server and said mobile electronics device using said shared network information; and maintaining application persistence by said remote server and said mobile electronics device using said shared network information.

31. The method of claim 30 wherein said step of maintaining session persistence further comprises the step of mimicking a first set of network parameters from said first selected network when using said second selected network, thereby maintaining session persistence via virtual addressing.

32. The method of claim 27 further comprising the step of pushing data by said remote server, responsive to said informing, to said mobile electronics device either prior to or after said switching.

33. The method of claim 27 further comprising said remote server operating to reduce data traffic, to optimize a transport protocol, to optimize an application protocol or to reduce duplication of work by a user through connection persistence or a combination thereof.

34. The method of claim 27 further comprising the steps of providing an application programming interface; and notifying, by said network switching software module, said one or more applications running on said mobile electronics device network of one or more network connectivity parameters via said application programming interface thereby initiating said step of sending said data from said application to said remote server.
